(19) United States
(12) Patent Application Publication
(10) Pub. No.: US 2008/0268100 A1
(43) Pub. Date: Oct. 30, 2008

(54) Low-Energy, Non-Fat Milk Beverage of High Calcium Content, and Method

(75) Inventors: Tiina Tervala, Kirkkonummi (FI); Tuula Tuure, Nurmijarvi (FI); Harri Kallioinen, Haarajoki (FI); Matti Harju, Nummela (FI)

Correspondence Address: NIXON & VANDERHYE, PC, 901 NORTH GLEBE ROAD, 11TH FLOOR, ARLINGTON, VA, 22203, US

(73) Assignee: Valio Ltd., Helsinki (FI)

(21) Appl. No.: 11/884,533

(22) PCT Filed: Dec. 8, 2005
(86) PCT No.: PCT/FI05/50454

§ 371 Date: Aug. 17, 2007

(30) Foreign Application Priority Data
Feb. 18, 2005 (FI) 20055076

(51) Int. Cl. A23C 9/20; A23C 9/158

(52) U.S. Cl. 426/73; 426/580; 426/587

(57) ABSTRACT

The invention relates to a low-energy, non-fat milk beverage of a high calcium content, the beverage containing a low-energy milk base which consists of non-fat milk, a whey protein solution or a combination thereof and from which carbohydrates have been removed either entirely or partly, and which is rich in calcium, and to a method for preparing the same.

### BACKGROUND OF THE INVENTION

The invention relates to a low-energy, non-fat milk beverage of high calcium content and to a method for preparing such a beverage.

There has been a clear interest in and a need for low-energy foodstuffs during recent years, obesity being at the same time a problem affecting increasing numbers of people in developed countries. Increasing weight problems especially among children and young people are of a particular interest in Finland as well.

A primary source of energy for humans consists of carbohydrates, proteins and fats. An essential aspect in weight loss is to reduce the amount of energy supplied by the diet. In obesity prevention, energy balance is the most critical factor. Reports from research made in recent years suggest that calcium, fibre, vitamin D and certain protein components of milk may have an effect on energy balance control.

Milk products are generally useful for lowering the glycaemic index of the diet. This means that the glucose level of blood after a meal does not rise as high as it would if the meal contained a lot of highly processed carbohydrates, i.e. products of high glycaemic index. A diet rich in products of high glycaemic index has been associated with central obesity, cardiovascular disease and type-2 diabetes.

WO 2004/075666 A2 relates to a reduced carbohydrate milk product and a method for preparing it. The raw material in this product is ultra filtered milk containing about 1 to 3% of carbohydrates, about 3 to 7% of proteins and 3 to 5% of fat. The milk product may also contain calcium, flavouring and sweeteners, for example.

A number of researches have confirmed the positive effect of calcium contained in milk on weight control. High calcium intake from milk products seems both to prevent weight gain and to improve the results of dieting. Milk has a stronger effect than calcium and, as a part of a low-energy diet, it reinforces weight loss. In addition, a strong reverse correlation has been observed between regular and high consumption of milk products and the development of metabolic syndrome in overweight adults. It has also been noticed that an increase in calcium intake from food reduces the internal calcium content of fat cells, the low calcium content of the cells reducing lipogenesis. Consequently, the calcium content of a cell has been observed to control lipometabolism.

### BRIEF DESCRIPTION OF THE INVENTION

It is an object of the invention to provide a low-energy milk beverage of good organoleptic properties and a method for preparing the beverage. This is achieved by a milk beverage and a method characterized by what is stated in the independent claims. The preferred embodiments of the invention are disclosed in the dependent claims.

The invention is based on a surprising discovery according to which substances combined according to the invention provide dieters, consumers suffering from the metabolic syndrome, such as high blood pressure, or diabetics with a suitable extremely low-energy milk beverage having good organoleptic properties. To create a milk beverage that tastes good, has good organoleptic properties and contains 20 kcal/100 g at the most, which is the definition for a low-energy product in Finland, poses a great challenge.

An advantage of the milk beverage of the invention is that it combines an optimal composition of nutrients that have a positive effect on weight control and on dietary treatment of diabetes and metabolic syndrome. The non-fat milk beverage of the invention has a low carbohydrate content and thereby an extremely low energy content, while its composition and taste still correspond to that of ordinary non-fat milk.

### BRIEF DESCRIPTION OF THE FIGURES

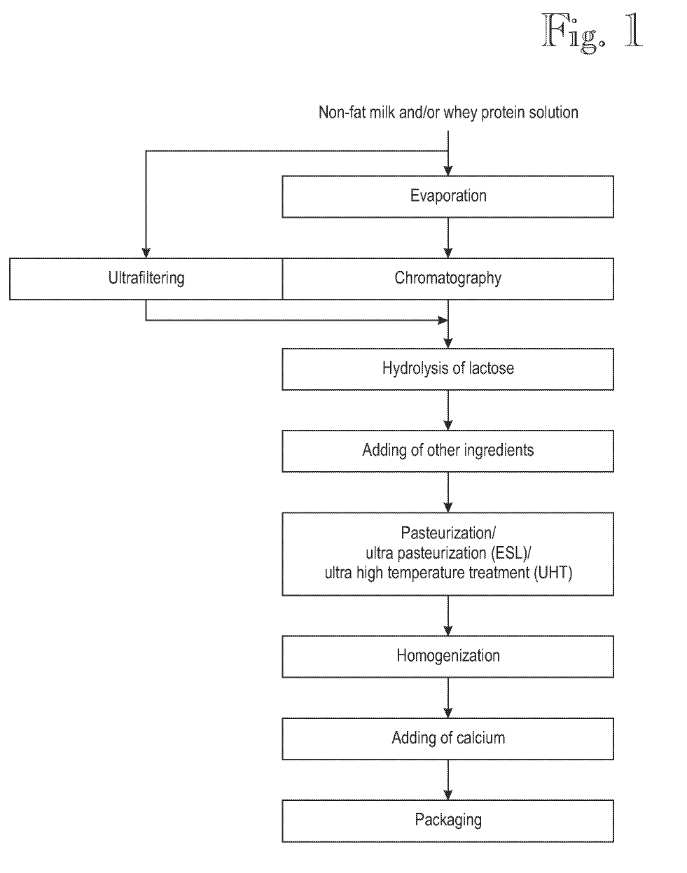

In the following the invention will be described in greater detail with reference to preferred embodiments. FIG. 1 is a block diagram illustrating a method according to one embodiment of the invention.

### DETAILED DESCRIPTION OF THE INVENTION

The invention relates to a low-energy, non-fat milk beverage characterized in that it contains a low-energy milk base, which consists of non-fat milk, a whey protein solution, or a mixture of the two and from which carbohydrates have been removed either partly or totally, and in that it is rich in calcium.

The protein content of milk contains 80% of casein proteins and 20% of whey proteins. Due to its amino acid composition and satiety-increasing effect, a whey protein fraction included in foodstuffs has been observed to have an advantageous effect on the metabolic syndrome and weight control. Compared with caseins and other protein sources, whey protein increases satiety and reduces the amount of food intake during subsequent meals. Thus the raw material used in the milk beverage of the invention is non-fat milk, a whey protein solution, or a mixture combining the two in any proportion. The milk base preferably consists of 100 to 10% of non-fat milk and 0 to 90% of whey protein solution, more preferably 70 to 50% of non-fat milk and 30 to 50% of whey protein solution.

Since the milk beverage of the invention is fat-free, the amount of fat it contains is less than 0.5%.

Carbohydrates are removed from the above raw material either entirely or partly to produce a low-energy product. This is done either by ultrafiltration or chromatographically according to known methods such that the total energy content of the milk beverage does not exceed 20 kcal/100 g.

Carbohydrates of milk are mainly derived from lactose. The preparation of a low-lactose or lactose-free milk product has been described in FI Application 20020907, for example. If lactose is removed by ultrafiltration, the salt content of the milk beverage must be returned to its original level by adding ordinary table salt or milk salts, for example. Preferably, only part of the lactose is removed such that the maximum final lactose content in the milk beverage of the invention is about 1.7 g/100 g of the milk beverage. If lactose is left in the final milk beverage, it is preferably hydrolysed to break down the lactose into glucose and galactose. Hydrolysis is achieved by means of lactase (β-galactosidase). Consequently, lactose contributes to the organoleptic properties of the milk beverage of the invention by providing sweetness and, thereby, improving the taste of the product.

The removal of carbohydrates or the reduction of an amount thereof from the raw material consisting of non-fat milk and/or whey protein results in what is known as a low-energy milk base. This milk base may then be complemented by soluble fibre. Fibre may have an impact on energy control through a plural number of mechanisms. First, fibre reduces the energy density of food. Fibre may also cause the stomach to expand due to increased salivation and secretion of gastric acid. Soluble fibre slows the evacuation of the stomach by forming a viscous gel matrix that contains nutrients and slows down the release of food from the stomach. This slows down digestion, whereby nutrients are absorbed more uniformly and the feeling of satiety lasts longer. Fibre may act on energy balance also through a hormonal mechanism. Fibre, and soluble fibre in particular, reduce the absorption of fat and protein possibly by reducing the physical contact between nutrients and the villi in the intestines.

The fibre in the milk beverage of the invention increases satiety by adding volume to the food mass. An increase in the daily intake of fibre reduces energy intake and thereby causes weight loss in the long term. Positive effects are achieved both by means of fibre obtained from natural sources and from a fibre supplement. Fibre also improves taste and thereby contributes to the organoleptic properties of the milk beverage of the invention. Examples of soluble fibre that may be added to the milk beverage of the invention include polydextrose, inulin, fructooligosaccharides, galactooligosaccharides, pectin, β-glucan, guar gum, xanthan gum, carrageen, and carob powder. Polydextrose is preferred. The maximum amount of added fibre is 3 g/100 g of the milk beverage, preferably 1.5 g/100 g.

The milk beverage of the invention is rich in calcium. As disclosed above, calcium has been discovered to have a positive effect on weight control. Calcium may be added to the milk beverage in different forms, for example in the form of Ca lactate gluconate, milk calcium, Ca gluconate, Ca lactate, Ca citrate or in some other soluble form of calcium salt. The milk beverage of the invention contains 120 to 240 mg of calcium in 100 g of the milk beverage, preferably 180 mg/100 g, which is 1.5 times the amount naturally contained in milk.

The milk beverage of the invention may also contain vitamin D. Vitamin D enhances calcium absorption and thereby, through calcium, has an indirect effect on energy balance. The amount of vitamin D in the milk beverage of the invention may be 0.1 to 1 μg/100 g, preferably 0.5 μg/100 g.

To further improve the organoleptic properties of the milk beverage of the invention, salt, as mentioned earlier, sweeteners and flavours may also be added to the beverage. Examples of suitable sweeteners include fructose, sucralose, acesulfame-K, aspartame, saccharine, and cyclamate.

The invention also relates to a method for preparing a low-energy, non-fat milk beverage of a high calcium content as described above. The method is characterized in that

non-fat milk, a whey protein solution, or a mixture of the two is ultra-filtered or, alternatively, evaporated and subjected to chromatography to remove carbohydrates or to reduce the amount thereof;

any remaining carbohydrates are hydrolysed, if desired;

fibre and vitamin D as well as any other additives, such as water, salt, sweetener, flavour, and other vitamins, are added;

the mixture thus obtained is subjected to pasteurisation, ultra pasteurisation or ultra high temperature treatment at a temperature of 72 to 145° C.;

the mixture is homogenised; and

calcium is added to the mixture.

In the method of the invention the raw material formed by the non-fat milk, the whey protein solution, or the mixture of the two is evaporated to a solids content of about 10 to 70%, preferably about 20 to 50%, more preferably about 30 to 40%. After the evaporation carbohydrates are removed from the concentrate or their amount is reduced by means of chromatography such that the total energy content of the remaining components does not exceed 20 kcal/100 g. Alternatively, carbohydrates are removed from the raw material by ultrafiltration. Remaining carbohydrates, i.e. mainly lactose, are preferably hydrolysed to introduce sweetness into the milk beverage and thereby improve its taste. If desired, salts, sweeteners and flavour may be added to the milk beverage to further improve its organoleptic properties. The mixture is then subjected to pasteurisation, ultra pasteurisation (ESL) or ultra high temperature treatment (UHT) at a temperature of 72 to 145° C. and homogenized in a pressure of 100 to 160 bars. Finally, calcium is added. To prevent proteins from precipitating in the thermal processing, this must be done after pasteurisation.

The following examples illustrate the invention.

### EXAMPLE 1

The raw material used in the milk beverage of the invention (“weight control drink”) is non-fat milk. A portion of the carbohydrates contained therein is removed by means of chromatographic separation or by ultrafiltration.

1. A Milk Protein Solution Prepared by Means of Chromatography

Non-fat milk is evaporated to a dry solids content of 30 g/100 g. A protein fraction having a carbohydrate (lactose) content of about 1.6 g/100 g and containing most of the milk salts is separated from the evaporated milk by means of chromatography. The compositions of the feed solution and the protein fraction are given in Table 1

TABLE 1

| | Feed solution | Protein fraction |
|---|---|---|
| Dry solids (g/100 g) | 30.0 | 8.9 |
| Protein (g/100 g) | 11.0 | 5.9 |
| Fat (g/100 g) | 0.3 | 0.1 |
| Carbohydrates (g/100 g) | 16.3 | 1.6 |
| Ash content (%) | 2.6 | 1.3 |
| Calcium (ppm) | 4000 | 2000 |

2. A Milk Protein Concentrate Prepared by Means of Ultrafiltration

Non-fat milk is supplied through an ultrafiltration device to obtain a retentate containing mainly milk proteins, lactose and a portion of the milk salts. The composition of the UF-retentate (the milk protein concentrate) is given in Table 2.

TABLE 2

| | Milk protein concentrate |
|---|---|
| Dry solids (g/100 g) | 19.8 |
| Protein (g/100 g) | 12.3 |
| Fat (g/100 g) | 0.2 |
| Carbohydrates (g/100 g) | 5.4 |
| Ash content (%) | 1.6 |
| Calcium (ppm) | 3800 |

The milk beverage of the invention is composed according to the following recipe:

| | |
|---|---|
| 27.000% | milk protein solution |
| 15.000% | milk protein concentrate |
| 55.472% | water |
| 0.200% | milk salts (Milk Mineral Powder, Valio Oy) |
| 0.657% | calcium lactate gluconate (Puracal Xperform, Purac) |
| 1.670% | polydextrose (Litesse Ultra, Danisco) |
| 0.001% | vitamin D solution (Kemikalia) |

The milk protein solution and the milk protein concentrate are hydrolysed enzymatically by means of a lactase enzyme in a container at a temperature of about 10° C. for about 10 hours. After the hydrolysis, water, milk salts and polydextrose are added under stirring to the milk protein mixture in the container. The solution is supplied through an ultra pasteurisation device (ESL, temperature 127° C., duration<1 sec.) and a homogeniser (pressure 160 bars). The calcium lactate gluconate is dissolved in hot water (in a proportion of 1:4 by mass) in a separate container and the solution is pumped into the milk-based solution into the product flow. The entire product is pumped into an aseptic package and forwarded to packaging. As a result, a milk beverage of the invention having a composition as shown in Table 3 is obtained.

TABLE 3

| | Weight control drink |
|---|---|
| Energy (kcal/100 g) | 20 |
| Protein (g/100 g) | 3.4 |
| Fat (g/100 g) | 0.05 |
| Carbohydrate (g/100 g) | 1.2 |
| of which lactose (g/100 g) | <0.01 |
| Calcium (mg/100 g) | 180 |
| Soluble fibre (g/100 g) | 1.5 |
| Vitamin D (μg/100 g) | 0.5 |
| Ash (g/100 g) | 0.7 |

The organoleptic properties of the product were considered good. Mouthfeel was described milky and the taste fresh and neutral. No off flavours were observed.

### EXAMPLE 2

The raw material in the milk beverage of the invention (“weight control drink”) is non-fat milk and a whey protein solution in a proportion of 10:90. The product is prepared by removing most of the carbohydrates in the non-fat milk and the whey protein solution by means of chromatographic separation.

Sweet whey obtained in cheese manufacture is nanofiltered to produce a whey protein solution in which the amount of whey proteins is about 3.3 g/100 g. The whey protein solution in question and the non-fat milk are combined so that about 10% of the total protein content of the mixture consists of proteins obtained from the non-fat milk and about 90% from proteins of the whey protein solution.

The milk protein-whey protein solution is evaporated to a dry solids content of about 40 g/100 g. A protein fraction having a carbohydrate (lactose) content of about 1.6 g/100 g and containing a portion of the salts of the milk and the whey is separated chromatographically from the evaporated mixture. The compositions of the feed solution and the protein fraction are given in Table 4.

TABLE 4

| | Feed solution | Protein fraction |
|---|---|---|
| Dry solids (g/100 g) | 40.0 | 6.8 |
| Protein (g/100 g) | 7.5 | 4.0 |
| Fat (g/100 g) | 0.3 | 0.1 |
| Carbohydrates (g/100 g) | 28.8 | 1.6 |
| Ash content (%) | 2.2 | 1.1 |
| Calcium (ppm) | 5200 | 2600 |

The milk beverage of the invention is composed according to the following recipe:

| | |
|---|---|
| 79.000% | protein fraction |
| 19.329% | water |
| 1.670% | polydextrose (Litesse Ultra, Danisco) |
| 0.001% | vitamin D solution (Kemikalia) |

The protein fraction is hydrolysed enzymatically (by means of a lactase enzyme) in a container at a temperature of about 10° C. for about 10 hours. After the hydrolysis, water and polydextrose are added under stirring to the protein mixture in the container. The solution is supplied through an ultra pasteurisation device (ESL, temperature 127° C., duration<1 sec.) and a homogeniser (pressure 160 bars). The calcium lactate gluconate is dissolved in hot water (in a proportion of 1:4 by mass) in a separate container and the solution is pumped into the milk-based solution into the product flow. The entire product is pumped into an aseptic package and forwarded to packaging. As a result, a milk beverage of the invention having a composition as shown in Table 5 is obtained.

TABLE 5

| | Weight control drink |
|---|---|
| Energy (kcal/100 g) | 20 |
| Protein (g/100 g) | 3.2 |
| Fat (g/100 g) | 0.08 |
| Carbohydrate (g/100 g) | 1.3 |
| of which lactose (g/100 g) | <0.01 |
| Calcium (mg/100 g) | 205 |
| Soluble fibre (g/100 g) | 1.5 |
| Vitamin D (μg/100 g) | 0.5 |
| Ash (g/100 g) | 0.9 |

The organoleptic properties of the product were considered good. Mouthfeel was described milky, slightly more watery than that of the product of Example 1. The taste was fresh and neutral. No off flavours were observed.

### EXAMPLE 3

The raw material in the milk beverage of the invention (“weight control drink”) is non-fat milk and a whey protein solution in a proportion of 60:40. The product is prepared by removing a portion of the carbohydrates in the non-fat milk and the whey protein solution by means of a chromatographic separation.

Sweet whey obtained in cheese manufacture is nanofiltered to produce a whey protein solution in which the amount of whey proteins is about 3.3 g/100 g. The whey protein solution in question and the non-fat milk are combined so that about 60% of the total protein content of the mixture consists of proteins obtained from the non-fat milk and about 40% of the proteins from the whey protein solution.

The milk protein-whey protein solution is evaporated to a dry solids content of about 35 g/100 g. A protein fraction having a carbohydrate (lactose) content of about 1.6 g/100 g and containing a portion of the salts of the milk and the whey is separated chromatographically from the evaporated mixture. The compositions of the feed solution and the protein fraction are given in Table 6.

TABLE 6

| | Feed solution | Protein fraction |
|---|---|---|
| Dry solids (g/100 g) | 35.0 | 7.3 |
| Protein (g/100 g) | 8.1 | 4.5 |
| Fat (g/100 g) | 0.3 | 0.1 |
| Carbohydrates (g/100 g) | 23.0 | 1.6 |
| Ash content (%) | 2.3 | 1.1 |
| Calcium (ppm) | 4500 | 2300 |

The milk beverage of the invention is composed according to the following recipe:

| | |
|---|---|
| 74.000% | protein fraction |
| 24.236% | water |
| 1.670% | polydextrose (Litesse Ultra, Danisco) |
| 0.093% | calcium lactate gluconate (Puracal Xperform, Purac) |
| 0.001% | vitamin D solution (Kemikalia) |

The protein fraction is hydrolysed enzymatically (by means of a lactase enzyme) in a container at a temperature of about 10° C. for about 10 hours. After the hydrolysis, water and polydextrose are added under stirring to the protein mixture in the container. The solution is supplied through an ultra pasteurisation device (ESL, temperature 127° C., duration<1 sec.) and a homogeniser (pressure 160 bars). The calcium lactate gluconate is dissolved in hot water (in a proportion of 1:4 by mass) in a separate container and the solution is pumped into the milk-based solution into the product flow. The entire product is pumped into an aseptic package and forwarded to packaging. As a result, a milk beverage of the invention having a composition as shown in Table 7 is obtained.

TABLE 7

| | Weight control drink |
|---|---|
| Energy (kcal/100 g) | 20 |
| Protein (g/100 g) | 3.3 |
| Fat (g/100 g) | 0.07 |
| Carbohydrate (g/100 g) | 1.3 |
| of which lactose (g/100 g) | <0.01 |
| Calcium (mg/100 g) | 180 |
| Soluble fibre (g/100 g) | 1.5 |
| Vitamin D (μg/100 g) | 0.5 |
| Ash (g/100 g) | 0.8 |

The organoleptic properties of the product were considered good. Mouthfeel was described milky. The taste was fresh and neutral. No off flavours were observed.

It is obvious to a person skilled in the art that as technology advances the basic idea of the invention can be implemented in various ways. The invention and its embodiments are therefore not restricted to the above examples but may vary within the scope of the claims.

1-12. (canceled)

13. A stabilizer-free, low-energy, non-fat milk beverage of a high calcium content, comprising a low-energy milk base that consists of non-fat milk, a whey protein solution or a mixture of the two and from which carbohydrates have been removed either entirely or partly, and added calcium, the amount of calcium being 120 to 240 mg/100 g of the milk beverage.

14. A milk beverage according to claim 13, wherein the milk base contains 100 to 10% of non-fat milk and 0 to 90% of whey protein solution, preferably 70 to 50% of non-fat milk and 30 to 50% of whey protein solution.

15. A milk beverage according to claim 13, wherein carbohydrates have been removed either entirely or partly, their amount in the final product being 1.7 g/100 g at the most.

16. A milk beverage according to claim 15, wherein the remaining carbohydrates are hydrolysed.

17. A milk beverage according to claim 13, wherein the amount of fat contained is less than 0.5 g/100 g of the milk beverage.

18. A milk beverage according to claim 13, wherein its energy content is 20 kcal/100 g at the most.

19. A milk beverage according to claim 13, wherein the amount of calcium it contains is 180 mg/100 g of the milk beverage.

20. A milk beverage according to claim 13, further comprising soluble fibre in an amount of up to 3 g/100 g, preferably 1.5 g/100 g of the milk beverage.

21. A milk beverage according to claim 20, wherein the fibre is polydextrose.

22. A milk beverage according to claim 13, further comprising vitamin D the in an amount of 0.1 to 1 μg/100 g, preferably 0.5 μg/100 g, of the milk beverage.

23. A method for preparing a milk beverage according to claim 13, wherein
non-fat milk, a whey protein solution or a combination of the two is ultrafiltered or, alternatively, evaporated and subjected to chromatography to remove carbohydrates or to reduce the amount thereof;
any remaining carbohydrates are hydrolysed, if desired;
fibre, vitamin D and other optional additives, such as water, salt, sweetener, flavour and other vitamins are added;
the mixture thus obtained is subjected to pasteurisation, ultra pasteurisation or ultra high temperature treatment at 72 to 145° C.;
the mixture is homogenised; and
calcium is added to the mixture.

24. A method according to claim 23, wherein the non-fat milk, the whey protein solution or the mixture thereof is evaporated to a dry solids content of about 10 to 70%, preferably about 20 to 50%, more preferably about 30 to 40%.
